(19) United States
(12) Patent Application Publication
(10) Pub. No.: US 2005/0109141 A1
(43) Pub. Date: May 26, 2005

(54) Automated mechanical transmission system

(76) Inventors: James Henry DeVore, Laurinburg, NC (US); Robert Anthony Sayman, Laurinburg, NC (US); Charles E. Allen JR., Rochester Hills, MI (US); Winfried Sturmer, Euerbach (DE); Karl-Fritz Heinzelmann, Meckenbeuren (DE); Ludger Ronge, Eriskirch (DE); Loren Christopher Dreier, Vass, NC (US); Ronald Peter Muetzel, Friedrichshafen (DE); Muneer AbuSamra, Southern Pines, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/721,647

(22) Filed: Nov. 25, 2003

(51) Int. Cl. F16H 59/00

(52) U.S. Cl. 74/336 R

(57) ABSTRACT

A transmission system which relates the relative movement of vehicle components to determine the onset of zero relative torque to permit a shift change to be effected at approximately zero relative torque. When a predetermined signature is identified which relates to the onset of zero relative torque the transmission shift controller initiates a shift.

### BACKGROUND OF THE INVENTION

The present invention relates to an automated mechanical transmission systems, and more particularly to an automated transmission system that identifies relative torques present within the power path to permit change of gear ratios.

Heavy vehicles have typically been provided with a manual or automatic clutch and an automatic, automated, or manual transmission. Automated transmission systems that change gear ratios without the assistance of a controllable master clutch must address the problem of how to disengage gears while under torque load. The torque load produces excess force at the gear interface and the resulting friction prevents movement within the limits of available control force. It is desirable, if not mandatory, that the load be relieved prior to disengagement.

The zero torque value at the gear interface changes dynamically with such factors as road conditions, vehicle condition, vehicle configuration, vehicle acceleration/deceleration, overall drive ratio, engine drag during coast among others. A zero torque target at the gear interface must normally be obtained using some combinations of measurements and/or physical models.

Current systems measure and/or model the absolute values of the external forces present to identify the zero torque value in terms of absolute torque at the engine and/or other power path points within the vehicle driveline. Disadvantageously, sensing of the absolute torque may be relatively complicated and subject the sensing members to significant stress which may thereby reduce their longevity.

Accordingly, it is desirable to provide an automated transmission system which identifies the zero torque value without the heretofore requirement of identifying absolute torque.

### SUMMARY OF THE INVENTION

The transmission system according to the present invention relates the relative movement of vehicle components to determine the onset of zero relative torque to permit a shift change to be effected at approximately zero relative torque. Generally, when a predetermined signature is identified which relates to the onset of zero relative torque, the transmission shift controller initiates a shift. Absolute torque of the components is irrelevant but relates the relative torques present at the gear interface or some other point in power path for that interface are utilized by the present invention.

The measurement of zero relative torque using that torque's effect on the system is achieved through the measurement of relative movement between two vehicle components which are separated by a gear interface such as torsional compliance at the clutch, measurement of torsional compliance in the transmission, measurement of the vibration signature from one or more speed sensors, measurement of the vibration signature from one or more acceleration sensors, and/or relative movement of two components.

The present invention therefore provides an automated transmission system which identifies the zero torque value without the heretofore requirement of identifying absolute torque.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a is a schematic block diagram of an automated transmission system which incorporates this invention;

FIG. 2 is an exploded view of a shaft arrangement according to the present invention;

FIG. 3 is a block diagram of another system according to the present invention;

FIG. 4 is a block diagram of another system according to the present invention;

FIG. 5 is a block diagram of another system according to the present invention;

FIG. 6 is a block diagram of another system according to the present invention;

FIG. 7 is a block diagram of another system according to the present invention; and

FIG. 8 is a block diagram of another system according to the present invention.

### DETAILED DESCRIPTION OF THE PREFERRED EMBODIMENT

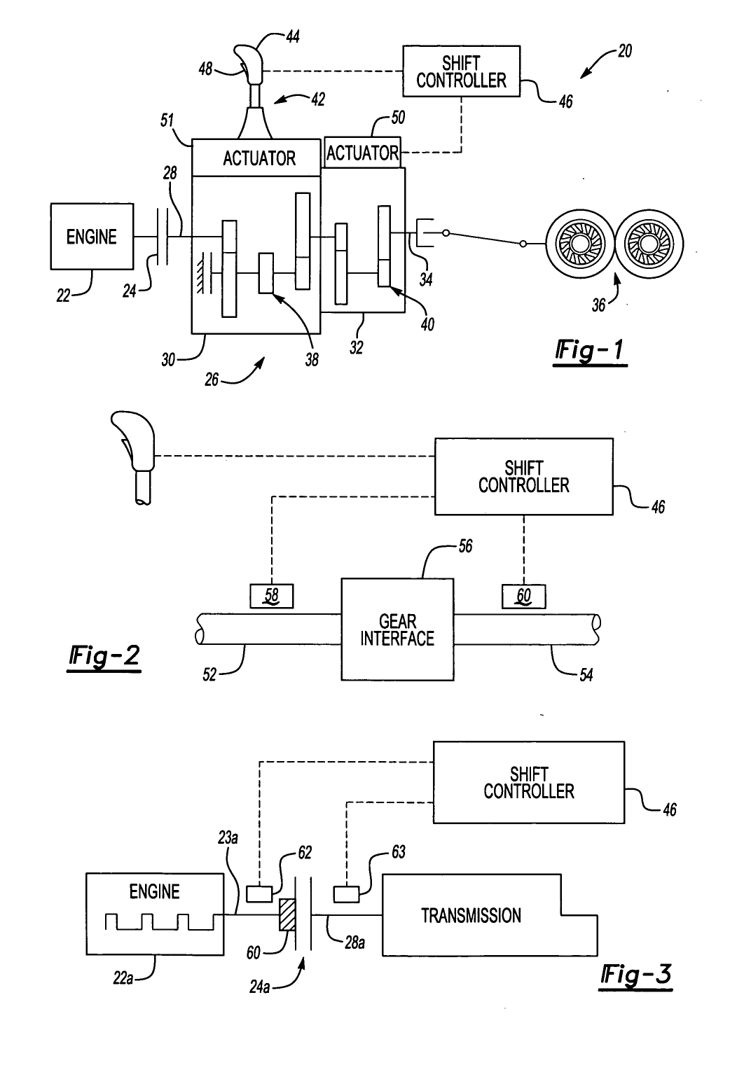

FIG. 1 diagrammatically illustrates a vehicle driveline 20 incorporating an engine 22 driving a clutch mechanism 24. The clutch mechanism 24 is selectively engaged to transmit power from the engine 22 into an automated mechanical transmission system 26. The clutch 24 can be a “dry clutch” or a “wet clutch”, a centrifugal clutch, releaser clutch, or any other known clutch mechanism.

The transmission 26 includes an input shaft 28 that is rotationally driven by the engine 22, a main section 30, an auxiliary section 32, and an output shaft 34 that rotatably drives one or more wheels 36 of the vehicle. As is well known, the main section 30 provides a first plurality of gears ratios 38, while the auxiliary section 32 provides a second plurality of gear ratios 40.

The transmission is shown schematically, and such automated transmissions are known in the art. Although this invention will be described in the context of a range type auxiliary section, it will be appreciated that this invention can be adapted for use in a splitter type auxiliary section.

A pivotable shift lever 42 is provided to effect shifting of the main section 30 of the transmission 26. The shift lever 42 is conventional in the art and includes an upper portion having a handle 44 mounted thereon that is moved by a driver of the vehicle to operate the actuator 50 and 51 of the automated main section 30 and the auxiliary section 32.

The transmission 26 is of the type provided by shift actuators 50 and 51 (illustrated schematically), such that transmission gear shifts are achieved without direct mechanical shifting by the driver. A shift controller 46 is connected between a driver actuatable switch 48 on the handle 44 and the shift actuators 50 and 51. The shift controller 46 is preferably any kind of electronic controller, such as a microprocessor or a programmable logic circuit which controls the actuators 50 and 51. The controller can be integrated with other system controllers located in the vehicle or its functions integrated with other controllers in a single processor for the whole vehicle.

Referring to FIG. 2, the shift controller 46 relates a relative movement signature to a zero relative torque condition between a first shaft 52 and a second shaft 54 which have a gear interface 56 therebetween. When the torque changes from “pull” to “push” or from “push” to “pull,” the gear clearance leads to relative movement of the shafts 52, 54 which indicates a zero torque condition between the shafts 52 and 54. Typically, a useful relative angle signal which is proportional to torque is not identified, because the stiffness is too high and the relative angle for zero torque is different after every gear change. Therefore, the change of the relative angle within the gear clearance is useful for the determination of zero torque. That is, zero torque=a relatively large change in relative angle at a relatively small change in engine torque. This is also valid with a clutch between the two sensors, as the relative angle is different after every drive-off or clutch actuation. The elasticity of the torsional damper may lead to a signal proportional to the torque but the relative angle for zero torque is not known when a shifting occurs immediately after a drive-off. Alternatively, a free travel or a pre-damper in the torsional damper (FIG. 3) of the clutch disc provides the same effect as with a gear clearance for the evaluation of zero torque.

The controller 46 communicates with a first sensor 58 adjacent the first shaft 52 and a second sensor 60 adjacent the second shaft 54. When the shift controller 46 identifies a relative movement signature indicative of a zero relative torque between the first and second shaft 52, 54 shifting of the gear interface 56 is initiated. It should be understood that the gear interface may be any gear interface within the transmission 26.

The sensors 58, 60 are preferably speed sensors. The signal of a speed sensor in a vehicle power train typically provides the speed and the irregularity of speed which depends on speed level, resonance speed and torque level. In this approach, the torque level is useful information, as the compliance of the driveline results in a speed and speed irregularity signature that changes with load. Real time analysis of the speed and speed irregularity generated by a speed sensors during operation reveals changes in the speed irregularity signature as the relative torque approached zero. From that signature, the controller 46 determines zero driveline torque such that a shift may be affected. Various, well known signal analysis logic may be utilized to relate the zero torque condition to a particular speed and speed irregularity signature or the like.

Another sensor 61 may alternatively or additionally be fastened at a position on the gearbox housing, where the housing vibrations relate to torque. The sensor 61 may measure travel, velocity, acceleration, structure-born sound and/or airborne sound to detect a vibration signature which is then related to torque. The sensor 61 locations include, but are not limited to the driveline, the transmission, or integrated in the transmission's electronic controller.

It should be understood that any number of components that have a relative movement capability within the vehicle driveline 20 will benefit from the present invention. Relating the relative movement to the approach of zero relative torque permits shift changes to be effected at approximately zero relative torque. Generally, when a predetermined signature is identified which relates to the onset of zero relative torque the controller initiates a shift. That is, absolute torque of the components is irrelevant as the present invention relates the relative torques adjacent the gear interface or some other point in power path for that interface to effect a shift. The measurement of zero relative torque using that torque's effect on the system is, for example and as will be further described below, achieved through the measurement of torsional compliance at the clutch, measurement of torsional compliance in the transmission, measurement of the vibration signature from one or more speed sensors, measurement of the vibration signature from one or more acceleration sensors, and/or relative movement of two components.

Referring to FIG. 3 and as explained with regard to FIG. 2, a torsional damper 60 is located within a vehicle clutch 24a as generally known. The torsional damper 60 permits relative movement between an engine shaft 23a and the transmission input shaft 28a when engaged by the clutch 24a. This relative movement results in a relative position change between the engine shaft 23a and the input shaft 28a in response to changing torque. A difference in relative position which indicates that the system is approaching zero relative torque. Sensor 62, 63 in communication with the shift controller 46 identifies the relative movement, and from that relative movement derives the relative driveline torque such that a shift is effected at approximately zero torque.

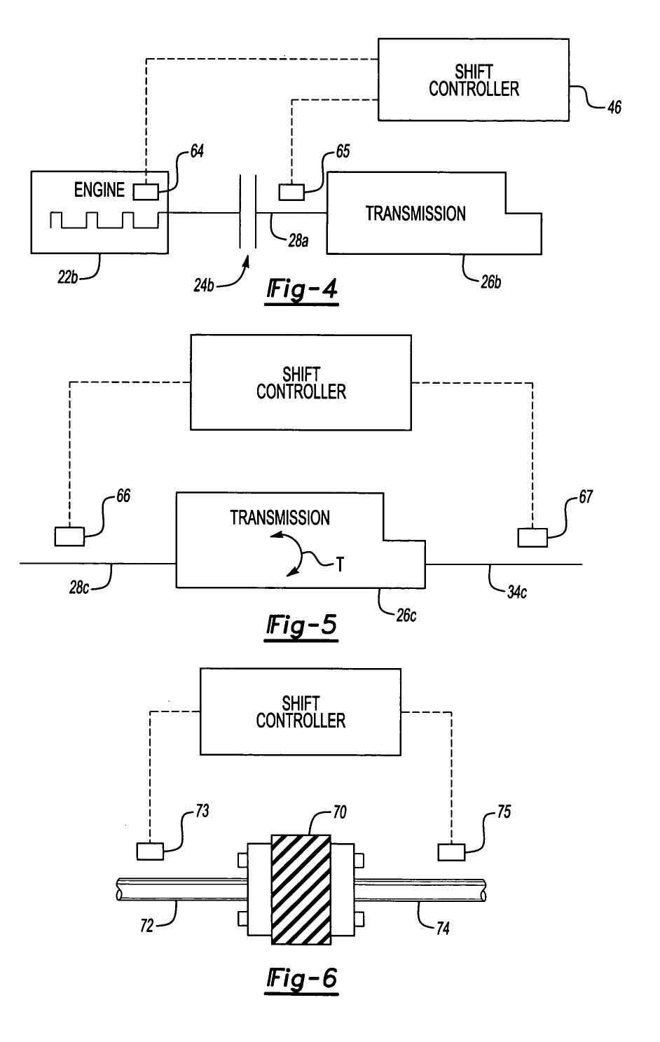

Referring to FIG. 4 and as explained with regard to FIG. 2, an engine speed sensor 64 in communication with the engine and a speed sensor 65 in communication with a transmission input shaft 28b. The sensors 64, 65 communicate with the shift controller 46 to detect the relative movement. That detection preferably utilizes the phase of the oscillations naturally present in each speed signal from the sensors 64, 65 rather than relative speeds of the two sensors. That is, the actual speed is not measured but the oscillations from the sensors 64, 65. When the oscillations are generally in phase the torque will be generally equivalent such that the shift may be effected at approximately zero torque.

Referring to FIG. 5 and as explained with regard to FIG. 2, the transmission 26c itself is not perfectly rigidly mounted and typically provides some torsional compliance (schematically illustrated by arrow T). The compliance of the transmission 26c produces relative movement between the transmission input shaft 28c and the transmission output shaft 34c. The relative movement generally changes as a function of the drive train torque. A transmission input and output speed sensor 66, 67 measures the relative movement and communicates the movement to the shift controller 46 such that a shift may be effected at zero relative torque.

Referring to FIG. 6, an elastomeric coupling 70 that permits torsional compliance that amplifies relative movement between a first shaft 72 and a second shaft 74. A first sensor 73 and a second sensor 75 are located adjacent each shaft 72, 74 to identify relative movement due to torsional deflection of the elastomeric coupling 70. It should be understood that the elastomeric coupling magnifies the torsional movement and that move across the sensor could be utilized without the elastomeric coupling 70. Such an arrangement may be utilized anywhere within the driveline.

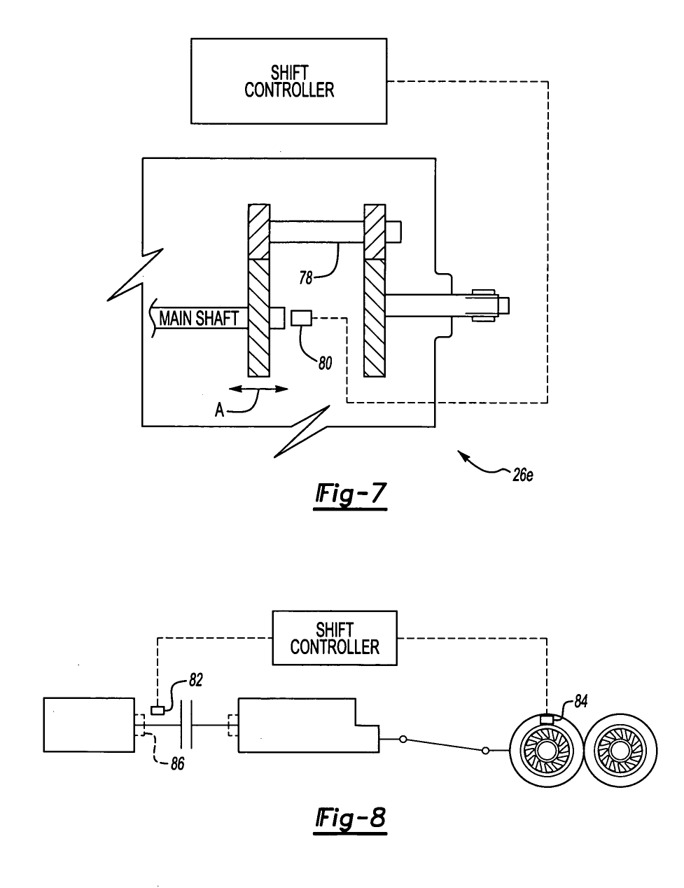

Referring to FIG. 7, a relative axial movement of a helical gear shaft 78 is related to the approach of zero relative torque. A sensor 80 preferably detects the axial movement (illustrated schematically by arrow A), however, the axial movement may alternatively or additionally be detected with a position sensor or a switch which is actuated only when the relative torque approaches zero.

Referring to FIG. 8 and as explained with regard to FIG. 2, a first and second sensor 82, 84 measures the relative torsional movement (twisting) between a first vehicle component 86 such as, for example only, a gear box output shaft, a flywheel, an input shaft, or the like and the vehicle wheels 88. The wheel position may be obtained from, for example only, an ABS sensor system.

It should be understood that although a particular component arrangement is disclosed in the illustrated embodiment, other arrangements will benefit from the instant invention.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A vehicle transmission system comprising:
an automated mechanical transmission shiftable between a first and a second gear ratio;
a first component;
a second component movable relative said first component;
a first sensor adjacent said first component;
a second sensor adjacent said second component;
a controller in communication with said fist sensor and said second sensor, said controller operable to determine a relative movement between said first component and said second component indicative of an approximately zero torque condition to initiate a shift between said first and said second gear ratio.

2. The vehicle transmission system as recited in claim 1, wherein said first and second sensor are speed sensors.

3. The vehicle transmission system as recited in claim 1, wherein said controller identifies a speed irregularity signature generated by said first and second sensor.

4. The vehicle transmission system as recited in claim 3, wherein said controller identifies a first noise signature component indicative of an approximately zero torque condition.

5. The vehicle transmission system as recited in claim 1, wherein said controller identifies a vibration signature.

6. The vehicle transmission system as recited in claim 1, wherein said first component comprises a shaft.

7. The vehicle transmission system as recited in claim 1, wherein said first component comprises a torsional damper.

8. The vehicle transmission system as recited in claim 1, wherein said first component comprises a transmission input shaft and said second component comprises a transmission output shaft.

9. The vehicle transmission system as recited in claim 1, wherein said first component comprises a vehicle wheel.

10. The vehicle transmission system as recited in claim 1, wherein said first component comprises a transmission housing.

11. The vehicle transmission system as recited in claim 1, wherein said relative movement comprises a torsion movement.

12. The vehicle transmission system as recited in claim 1, wherein said relative movement comprises an axial movement.

13. A method of controlling a vehicle transmission comprising the steps of:
(1) determining a relative movement between a first component and a second component;
(2) relating the relative movement of said step (1) to an approximately zero torque condition; and
(3) shifting the vehicle transmission between a first and a second gear ratio in response to identification of the zero torque condition.

14. A method as recited in claim 13 wherein said step (1) comprises determining a torsion movement.

15. A method as recited in claim 13 wherein said step (1) comprises determining an axial movement.

16. A method as recited in claim 13, wherein said step (1) comprises:
determining a vibration.

17. A method of controlling a vehicle transmission comprising the steps of:
(1) determining a speed irregularity between a first component and a second component;
(2) relating the speed irregularity of said step (1) to an approximately zero torque condition; and
(3) shifting the vehicle transmission between a first and a second gear ratio in response to identification of the zero torque condition.
